(19) United States
(12) Patent Application Publication
(10) Pub. No.: US 2009/0258985 A1
(43) Pub. Date: Oct. 15, 2009

(54) Compositions for humidity proof heat sealer having low specific gravity

(75) Inventor: Kyu Saeng Choi, Ulsan (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/291,121

(22) Filed: Nov. 5, 2008

(30) Foreign Application Priority Data
Apr. 10, 2008 (KR) 10-2008-0033365

(51) Int. Cl. C08K 3/26

(52) U.S. Cl. 524/425

(57) ABSTRACT

The present invention relates to humidity-proof heat sealer compositions having low specific gravity, which comprise a polyvinyl chloride resin, a filler, a moisture absorbent, a plasticizer, an adhesion promoter, an additive, and so forth, for use in automotive steel sheet joints or outside panel joints. When compared with conventional sealer compositions, the present compositions provide improved humidity resistance, as well as improved fuel efficiency.

### CROSS-REFERENCE TO RELATED APPLICATION

This application claims under 35 U.S.C. §119(a) the benefit of Korean Patent Application No. 10-2008-0033365 filed Apr. 10, 2008, the entire contents of which are incorporated herein by reference.

### TECHNICAL FIELD

The present invention relates to a composition for humidity proof heat sealer having low specific gravity, which comprises a polyvinyl chloride resin, a filler, a moisture absorbent, a plasticizer, an adhesion promoter, an additive, and so forth.

### BACKGROUND ART

In an automotive manufacturing process, sealers are applied to an automotive steel sheet joint prior to painting in order to prevent water leakage, rusting and noise, as illustrated in FIG. 1.

For conventional sealers, as disclosed in Korean Patent Application No. 2001-41257, they are cured by heat while passing through ovens used for bottom, middle and top coating processes, as illustrated in FIG. 2.

During long weekends, holidays or vacations, automobiles should be kept under stage 1 or 2. When automobiles are placed in hot and humid weather conditions for a long period of time, moisture contained in the air slowly ingresses into the conventional sealers, as illustrated in FIG. 4. The sealers which have absorbed moisture pass through ovens may cause inferiority in product appearance, as illustrated in FIG. 4, which requires re-working.

In order to solve this problem, when long weekends or holidays come, for instance, 60 to 70 automobiles and 90 to 100 automobiles are taken, ahead of schedule, to stage 3 from stage 1 and stage 2, respectively. However, in this case, the empty stages 1 and 2 have to be filled to resume work after the long weekends or holidays.

Further, the conventional sealers have a very high specific gravity of around 1.7 and about 7 to 8 kg of the sealers is used for manufacturing an automobile, which increases the overall weight of the automobile and decreases, in turn, fuel efficiency.

Accordingly, there has been a need for a new sealer that can solve the above-described problems.

The above information disclosed in this Background section is only for enhancement of understanding of the background of the invention and therefore it may contain information that does not form the prior art that is already known in this country to a person of ordinary skill in the art.

### SUMMARY

An object of the present invention is to provide sealer compositions with strong humidity resistance and reduced weight.

In an aspect, the present invention provides compositions for humidity proof heat sealer having low specific gravity, which comprise:

(1) 20 to 35 weight % of a polyvinyl chloride resin;

(2) 20 to 35 weight % of a filler comprising 60 to 95 weight % of calcium carbonate, 2 to 20 weight % of hollow microspheres and 2 to 20 weight % of microspheres;

(3) 5 to 10 weight % of a moisture absorbent comprising 50 to 75 weight % of non-coated calcium oxide and 25 to 50 weight % of coated calcium oxide;

(4) 25 to 35 weight % of a plasticizer;

(5) 1 to 15 weight % of an adhesion promoter; and

(6) 1 to 5 weight % of a heat stabilizer.

With the above-described compositions, quality problems caused by moisture absorption can be solved. Fuel efficiency can be improved by reducing the sealer coating weight by at least about 25% through reducing average specific gravity to 1.3 or lower.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

The above and other aspects and features of the invention are discussed infra.

### DESCRIPTION OF DRAWINGS

The above and other objects, features and other advantageous of the present invention will be more clearly understood from the following detailed description taken in conjunction with the accompanying drawings, in which:

FIG. 1 illustrates a process of applying a sealer on an automotive panel joint.

FIG. 2 illustrates a process of heat-curing a sealer.

FIG. 3 shows appearance change of a sealer which does not absorb moisture during heat curing.

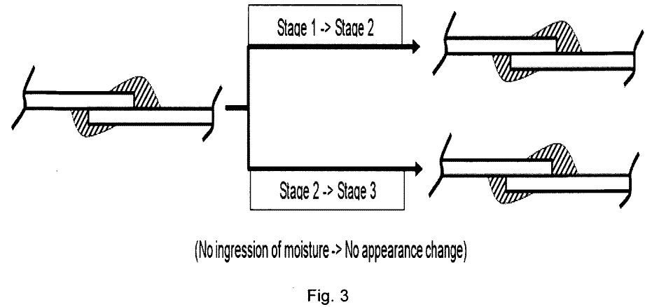

FIG. 4 shows appearance change of a sealer which absorbs moisture during heat curing.

### DETAILED DESCRIPTION

Hereinafter reference will now be made in detail to various embodiments of the present invention, examples of which are illustrated in the accompanying drawings and described below.

Preferably, the sealer composition according to the present invention comprises: (1) 20 to 35 weight % of a polyvinyl chloride resin; (2) 20 to 35 weight % of a filler comprising 60 to 95 weight % of calcium carbonate, 2 to 20 weight % of hollow microspheres and 2 to 20 weight % of microspheres; (3) 5 to 10 weight % of a moisture absorbent comprising 50 to 75 weight % of non-coated calcium oxide and 25 to 50 weight % of coated calcium oxide; (4) 25 to 35 weight % of a plasticizer; (5) 1 to 15 weight % of an adhesion promoter; and (6) 1 to 5 weight % of a heat stabilizer.

The polyvinyl chloride resin is used herein to form a soft film with strong elasticity along with the plasticizer, and provide water-proof, rust-proof and noise-proof properties to an automotive steel sheet joint.

Preferably, it is used in an amount of 20 to 35 weight % of based on the total weight of the sealer composition. When the content is less than 20 weight %, problems may occur in water-proof, rust-proof or noise-proof properties because of insufficient elasticity and strength. On the other hand, when the content exceeds 35 weight %, the film may be peeled off.

The polyvinyl chloride resin is a paste resin, and may be at least one selected from a homopolymer resin, copolymer resin and a blend resin. More preferably, 30 to 55 weight % of a homopolymer resin, 30 to 55 weight % of a copolymer resin and 10 to 25 weight % of a blend resin are used based on 100 weight % of the total polyvinyl chloride resin to attain improved mechanical properties such as wear resistance and chipping resistance after the film formation and, thereby, superior rust-proof and water-proof properties. When the content of the homopolymer resin is less than 30 weight %, wear resistance and chipping resistance may be deteriorated. In contrast, when it exceeds 55 weight %, storage stability and ejection workability may be deteriorated. When the content of the copolymer resin is less than 30 weight %, wear resistance and chipping resistance may be deteriorated. By contrast, when it exceeds 55 weight %, storage stability and ejection workability may be deteriorated. When the content of the blend resin is less than 10 weight %, workability, wear resistance and chipping resistance may be deteriorated because of reduced ejection volume. On the other hand, when it exceeds 25 weight %, storage stability may be deteriorated. Therefore, it is preferable to use the homopolymer resin, the copolymer resin and the blend resin in the aforesaid ranges.

Suitably, the homopolymer resin may have a molecular weight in the range from 950 to 1600. The copolymer resin may suitably have a molecular weight in the range from 1000 to 1400. And, the blend resin may suitably have a molecular weight in the range from 1300 to 1500. When the molecular weight of the homopolymer resin is less than 950, viscosity may increase during storage at high temperature (40° C.) while when the molecular weight exceeds 1600, film may not be formed at 135° C. within 30 minutes. When the molecular weight of the copolymer resin is less than 1000, viscosity may increase during storage at high temperature (40° C.). On the other hand, when the molecular weight exceeds 1400, film peel-off may occur under the heating condition of 135° C. and within 30 minutes. When the molecular weight of the blend resin is less than 1300, viscosity may increase during storage at high temperature (40° C.). In contrast, when the molecular weight exceeds 1600, film may not be formed at 135° C. within 30 minutes. Therefore, it is preferable to use the homopolymer resin, the copolymer resin and the blend resin having molecular weights of the aforesaid ranges.

The filler is used herein to improve workability, prevent flow, maintain hardness and reduce specific gravity. Preferably, it may be used in an amount of 20 to 35 weight % based on the total weight of the sealer composition having low specific gravity. When the content is less than 20 weight %, flowability of the sealer may be excessive. On the other hand, when it exceeds 35 weight %, elasticity of the sealer is reduced and film breakage may occur. Hence, the aforesaid range is preferred.

In an embodiment of the present invention, the filler may comprise 60 to 95 weight % of calcium carbonate, 2 to 20 weight % of a hollow microsphere and 2 to 20 weight % of a microsphere, based on the total weight of the filler.

Preferably, the calcium carbonate has a specific gravity of 1.7 to 1.9.

The terms “hollow microsphere” and “microsphere” are commonly used to refer to a filler having a low specific gravity. In this disclosure, however, the term “hollow microsphere” refers to a filler having a specific gravity of 0.7 to 0.9 and the term “microsphere” refers to a filler having a specific gravity of 0.05 to 0.1. For instance, a filler having a specific gravity of 0.7 to 0.9 and that of 0.05 to 0.1 marketed by 3M Japan can be used as the hollow microsphere and the microsphere, respectively. Preferably, the hollow microsphere may have a pressure resistance of 550 to 650 psi.

The hollow microspheres may, suitably, be used in an amount of 2 to 20 weight % based on the total weight of the filler. When the amount is less than 2 weight %, weight of the sealer increases because of relative increase in the amount of calcium carbonate. On the other hand, when it exceeds 20 weight %, ejection workability may be deteriorated.

Meanwhile, the microspheres having specific gravity of 0.05 to 0.1 are used in an amount of 2 to 20 weight % of based on the total weight of the filler. When the amount is less than 2 weight %, weight % based on the total weight of the filler. When the amount is less than 2 weight %, the weight of the sealer increases because of the relative increase in the amount of calcium carbonate. When it exceeds 20 weight %, weight can be reduced, but flowability may be deteriorated. It is preferable that the filler be a mixture of the calcium carbonate, the hollow microspheres and the microspheres.

When the hollow microsphere is used alone, there may occur cracking during bending test because hardness increases after curing. And, when the microsphere is used alone, hardness may decrease after curing. Therefore, it is preferred to use them in combination, in view of cracking prevention and hardness control. Further, by using the hollow microsphere and the microsphere in addition to calcium carbonate, it is possible to remarkably reduce the weight of the sealer composition.

In a preferred embodiment of the present invention, the moisture absorbent is used in an amount of 5 to 10 weight % based on the total weight of the sealer composition. When the content is less than 5 weight %, foaming may be generated during curing because of moisture absorption. When it exceeds 10 weight %, whitening and cracking may occur on the surface of the sealer.

The moisture absorbent may suitably comprise non-coated calcium oxide and coated calcium oxide. The coated calcium oxide is prepared by coating the surface of non-coated calcium oxide with fatty acid, and serves to prevent foaming caused by moisture absorption upon extended exposure to moisture.

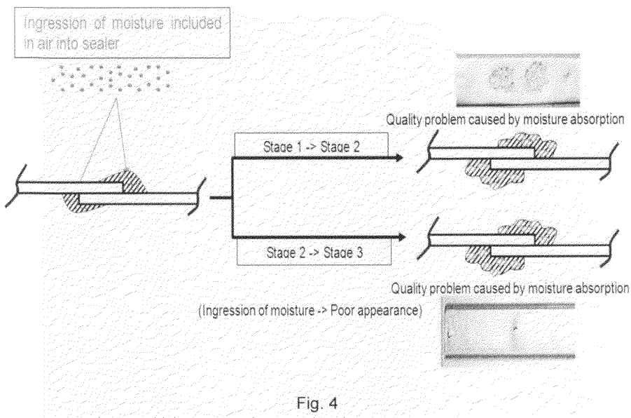

The non-coated calcium oxide may be included in an amount of 50 to 75 weight % based on the total weight of the moisture absorbent. When the amount is less than 50 weight %, foaming may occur during curing, as can be seen in FIG. 4, because of the moisture remaining without being removed. On the other hand, when it exceeds 75 weight %, whitening and cracking may occur on the surface of the sealer. The coated calcium oxide may be included in an amount of 25 to 50 weight % of based on the total weight of the moisture absorbent. When the amount is less than 25 weight %, foaming may occur upon long-term storage. On the other hand, when it exceeds 50 weight %, whitening and cracking may occur on the surface of the sealer.

The plasticizer is used to solate the polyvinyl chloride resin to provide the polyvinyl chloride resin with coating workability and soft elasticity during curing. Preferably, the plasticizer is used in an amount of 25 to 35 weight % based on the total weight of the sealer composition of the present invention. When the content is less than 25 weight %, coating workability may be deteriorated because of high viscosity. On the other hand, when it exceeds 35 weight %, film strength may decrease because of decreased viscosity. The plasticizer may be, preferably, a polyester based plasticizer or a phthalate based plasticizer. For instance, at least one selected from diethylhexyl phthalate (DEHP), dibutyl phthalate (DBP), diisononyl phthalate (DINP), diisodecyl phthalate (DIDP) and butylbenzyl phthalate may be used.

The adhesion promoter is used to provide adhesivity to an adherend, and is preferably used in an amount of 1 to 15 weight % based on the total weight of the sealer composition of the present invention. When the content is less than 1 weight %, adhesivity to an adherend may be insufficient. On the other hand, when it exceeds 15 weight %, film cracking may occur because of increased hardness of the sealer composition.

The adhesion promoter may comprise at least one selected from a urethane modified amide resin and an epoxy resin. When both of them are used, the urethane modified amide and the epoxy resin may be mixed at a proportion of 1 to 0.5 based on weight. When the mixing ratio exceeds 1:1, storage stability may be deteriorated. When it is below 1:0.5, discoloration and decrease of adhesivity may occur after curing.

In an embodiment of the present invention, the heat stabilizer may be at least one selected from a zinc based stabilizer, a tin based stabilizer and a calcium-zinc based stabilizer. More preferably, at least one selected from zinc oxide, which is a zinc based stabilizer, a calcium-zinc based stabilizer and a tin based stabilizer may be used. The heat stabilizer is used in an amount of 1 to 5 weight % based on the total weight of the sealer composition of the present invention. When the amount of the heat stabilizer is less than 1 weight %, the polyvinyl chloride resin may be discolored. When it exceeds 5 weight %, adhesivity may be deteriorated.

In an embodiment, the sealer composition may further comprise a low boiling point solvent having viscosity of 2 to 2.5 cst (centistokes, ASTM D-445) at 40° C., in order to reduce viscosity. Preferably, the low boiling point solvent is used in an amount of 1 to 5 parts by weight, more preferably 1 to 3 parts by weight, based on 100 parts by weight the sealer composition. When the low boiling point solvent is used in an amount less than 1 part by weight, the intended effect may not be attained. When it is used in an amount exceeding 5 parts by weight, the solid content may decrease. Hence, the aforesaid range is preferred.

The sealer composition having the constituents as described above has average specific gravity in the range from 1.1 to 1.3.

### EXAMPLES

The following examples further illustrate the present invention and are not intended to limit the same.

### Examples 1-6

Compositions for humidity proof heat sealer having low specific gravity according to the present invention was prepared. The components listed in Table 1 below were mixed in a batch type kneader commonly used by those skilled in the related art. After mixing and dispersing the sealer composition at 25° C. to 35° C. followed by vacuum degassing, the sealer composition was prepared, which has a viscosity of 150,000 to 250,000 cps (centipoises).

### Comparative Examples 1 and 2

In Comparative Example 1, a sealer composition was prepared by a batch-type kneader with components and compositions described in Table 1. In Comparative Example 2, a sealer composition was prepared as described in the Example section of Korean Patent Application No. 2001-41257.

TABLE 1

| | | | | | | | | Comp. | Comp. |
|---|---|---|---|---|---|---|---|---|---|
| Components (weight %) | | Ex. 1 | Ex. 2 | Ex. 3 | Ex. 4 | Ex. 5 | Ex. 6 | Ex. 1 | Ex. 2 |
| Polyvinyl | Homopolymer | 40 | 40 | 40 | 45 | 40 | 50 | 40 | 45 |
| chloride | Copolymer | 40 | 40 | 40 | 45 | 40 | 35 | 55 | 40 |
| resin | Blend resin | 20 | 20 | 20 | 10 | 20 | 15 | 5 | 15 |
| | Amount | 25 | 25 | 25 | 30 | 35 | 30 | 17 | 28 |
| Filler | Non-coated GCC | — | — | — | — | — | — | 60 | 65 |
| | Calcium carbonate | 60 | 84 | 60 | 60 | 60 | 80 | 40 | 35 |
| | Hollow microspheres | 20 | 8 | 20 | 20 | 20 | 15 | — | — |
| | Microspheres | 20 | 8 | 20 | 20 | 20 | 5 | — | — |
| | Amount | 30 | 30 | 30 | 25 | 20 | 25 | 53.5 | 35.35 |
| Adhesion | Urethane modified | 5 | 5 | 5 | 5 | 5 | 5 | 2.5 | 2 |
| promoter | amide | | | | | | | | |
| | Epoxy resin | — | — | 2 | 2 | — | — | — | 1 |
| Plasticizer | DINP | 32 | 32 | 30 | 30 | 30 | 32 | 25 | 30 |
| Moisture | Non-coated calcium | 60 | 60 | 70 | 70 | 60 | 65 | 100 | 100 |
| absorbent | oxide | | | | | | | | |
| | Coated calcium oxide | 40 | 40 | 30 | 30 | 40 | 35 | — | — |
| | Amount | 7 | 7 | 7 | 7 | 8 | 7 | 1 | 1.2 |
| Colorant | Carbon black | — | — | — | — | — | — | — | 0.05 |
| Heat | Zinc oxide | 1 | 1 | 1 | 1 | 2 | 1 | 1 | 2.4 |
| stabilizer | | | | | | | | | |

| Total weight % (parts by weight) | 100 weight % (parts by weight) | | | | | | | |
|---|---|---|---|---|---|---|---|---|
| Low boiling point plasticizer | 3 | 3 | — | 2 | 1 | 2 | 2 | 6.5 |
| parts by weight) | | | | | | | | |

1. Polyvinyl chloride resin
1) Homopolymer: average molecular weight = 1,100 to 1,200, LG Chem
2) Copolymer: average molecular weight = 1,150 to 1,250, LG Chem
3) Blend resin: average molecular weight = 1,500 to 1,550, Hanyang Chemical
2. Filler
1) Non-coated GCC (ground calcium carbonate): Omya GCC, Wangpyo Chemical
2) Calcium carbonate: Shirai Chemical
3) Hollow microspheres: specific gravity = 0.8, pressure resistance = 570 psi, 3M
4) Microspheres: specific gravity = 0.07, 3M
3. DINP: Aekyung Chemical
4. Adhesion promoter
1) Urethane modified amide: Kukdo Chemical
2) Epoxy resin: Wookjun Chemical
5. Moisture absorbent
1) Non-coated calcium oxide: Wangpyo Chemical
2) Coated calcium oxide: Wangpyo Chemical
6. Heat stabilizer: Choyang Chemical

### TEST EXAMPLES

### Test Example 1

Specific gravity of each of the sealer compositions prepared in Examples 1-6 and Comparative Examples 1-2 was measured. The result is presented in Table 2 below.

1. Specific Gravity Measurement

The compositions each were filled in a container with known volume according to the water substitution method, so that no air or impurities were included. Specific gravity was calculated by measuring the weight of the each of compositions.

2. Calculation of Consumption Amount of Sealer (kg/Automobile)

Consumption amount of sealer composition=(consumption amount of the sealer composition according to Comparative Example 1)×(specific gravity of each of the sealer compositions according to Examples)/(specific gravity of the sealer composition according to Comparative Example 1)

3. Calculation of Compensated Specific Gravity Reduction (%)

Compensated specific gravity reduction (%)=[(specific gravity of each of the sealer compositions according to Examples)/(specific gravity of the sealer composition according to Comparative Example 1)×100%]-100%

4. Cost Rate (%)

Cost rate (%)=(consumption amount of sealer composition)×(material cost rate)

TABLE 2

| | | | | Specific | | |
|---|---|---|---|---|---|---|
| | | Sealer consumption | | gravity | | |
| | | (kg/automobile) | | compensated | Material | Cost rate/ |
| | Specific | Actual | Reduced | consumption | cost rate | automobile |
| | gravity | consumption | amount | reduction (%) | (%) | (%) |
| Comparative | 1.69 | 7-8 | 0 | 0 | 100 | 700-800 |
| Example 1 | | | | | | |
| Comparative | 1.67 | 6.9-7.9 | −0.08-−0.09 | −1.18 | 101 | 699-799 |
| Example 2 | | | | | | |
| Example 1 | 1.19 | 4.9-5.6 | −2.0-−2.4 | −29.6 | 125 | 616-704 |
| Example 2 | 1.28 | 5.3-5.8 | −1.4-−1.7 | −24.3 | 117 | 620-709 |
| Example 3 | 1.18 | 4.9-5.6 | −2.0-−2.4 | −30.2 | 126 | 616-704 |
| Example 4 | 1.20 | 5.0-5.8 | −1.4-−1.7 | −29.0 | 124 | 616-704 |
| Example 5 | 1.17 | 4.8-5.5 | −2.0-−2.4 | −30.8 | 127 | 615-703 |
| Example 6 | 1.25 | 5.1-5.6 | −1.5-−2.1 | −26.0 | 120 | 621-710 |

As seen in Table 2, the sealer compositions of Comparative Examples 1 and 2 were consumed in an amount of 7 to 8 kg per each automobile. In contrast, the sealer compositions of Examples 1 to 6 were consumed in an amount of 4.9 to 5.6 kg because they have significantly low specific gravity. This means that according to the present invention, the weight of the automobile can be reduced, which is expected to contribute to the improvement of fuel efficiency and the cost reduction.

### Test Example 2

Measurement of Humidity Resistance

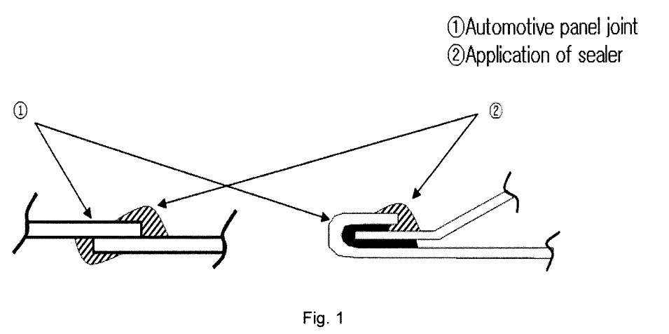

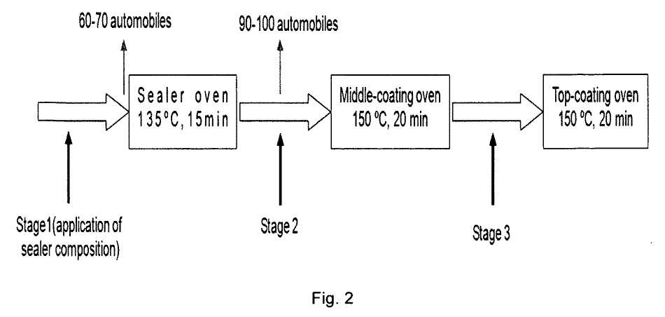

Test samples were prepared from the sealer compositions prepared in Examples and Comparative Examples, as illustrated in FIG. 1. The test samples were kept under stage 1 and stage 2, as illustrated in FIG. 2, for 7 days, and it was observed whether bubbles appeared. In stage 1, each test sample was kept under the condition of 35° C. and 90% humidity for 1 to 7 days. Then, after bake hardening at 135° C. for 15 minutes, it was observed whether bubbles appeared. In stage 2, each test sample that had been bake hardened in stage 1 was further bake hardened at 150° C. for 20 minutes. Then, it was observed whether bubbles appeared.

TABLE 3

| | | Appearance of bubbles (after kept at 35° C., 90% humidity) | | | | | | |
|---|---|---|---|---|---|---|---|---|
| | | 1 day | 2 days | 3 days | 4 days | 5 days | 6 days | 7 days |
| Stage 1 | Comp. Ex. 1 | No | Yes | Yes | Yes | Yes | Yes | Yes |
| | Comp. Ex. 2 | No | Yes | Yes | Yes | Yes | Yes | Yes |
| | Ex. 1 | No | No | No | No | No | Yes | Yes |
| | Ex. 2 | No | No | No | No | No | No | Yes |
| | Ex. 3 | No | No | No | No | No | Yes | Yes |
| | Ex. 4 | No | No | No | No | No | Yes | Yes |
| | Ex. 5 | No | No | No | No | No | No | Yes |
| | Ex. 6 | No | No | No | No | No | Yes | Yes |
| Stage 2 | Comp. Ex. 1 | No | No | Yes | Yes | Yes | Yes | Yes |
| | Comp. Ex. 2 | No | No | Yes | Yes | Yes | Yes | Yes |
| | Ex. 1 | No | No | No | No | No | No | No |
| | Ex. 2 | No | No | No | No | No | No | No |
| | Ex. 3 | No | No | No | No | No | No | No |
| | Ex. 4 | No | No | No | No | No | No | Yes |
| | Ex. 5 | No | No | No | No | No | No | No |
| | Ex. 6 | No | No | No | No | No | No | Yes |

As seen in Table 3, the sealer compositions of Comparative Examples 1 and 2 showed inferior appearance when the samples were kept under stage 1 for more than 1 day and under stage 2 for more than 2 days, as illustrated in FIG. 4. In contrast, the sealer compositions of Examples 1 to 6 did not show such a problem even when the samples were kept under stage 1 for 5 or more days, and under stage 2 for 7 days.

### Test Example 3

Measurement of Physical Properties

Physical properties of the sealer compositions prepared in Example 1, Example 3, Example 6 and Comparative Examples 1-2 were measured. The result is presented in the following Table 4.

TABLE 4

| | | Comp. | Comp. | | | | |
|---|---|---|---|---|---|---|---|
| | | Ex. 1 | Ex. 2 | Ex. 1 | Ex. 3 | Ex. 6 | Requirements |
| Fluidity | | Good | Good | Good | Good | Good | 120 mm or lower |
| Workability | Ductility | 68 | 71 | 79 | 75 | 77 | Within 50-100 mm |
| | Curability | Good | Good | Good | Good | Good | No bubbling, |
| | | | | | | | cracking or peeling |
| Adhesion strength (kg/cm²) | | 10.6 | 11.2 | 11.4 | 10.9 | 11.2 | At least 7 |
| Cold resistance | Appearance | Good | Good | Good | Good | Good | No cracking |
| (−30 ± 2° C., 3 hr) | Tightness | Good | Good | Good | Good | Good | No peeling at |
| | | | | | | | interface |
| Heat resistant | Appearance | Good | Good | Good | Good | Good | No discoloration or |
| cyclability (130-165° C., | | | | | | | cracking |
| 30 min each) | Tightness | Good | Good | Good | Good | Good | No peeling at |
| | | | | | | | interface |
| Water proofness | Appearance | Good | Good | Good | Good | Good | No discoloration or |
| (40 ± 2° C., 168 hr) | | | | | | | cracking |
| | Tightness | Good | Good | Good | Good | Good | No peeling at |
| | | | | | | | interface |
| Finish Coating | Appearance | Good | Good | Good | Good | Good | No coatiability |
| resistant | | | | | | | problem |
| | Adhesivity | Good | Good | Good | Good | Good | No peeling at |
| | | | | | | | interface |

| | | | | | | |
|---|---|---|---|---|---|---|
| Storage stability | 21.3 | 21.7 | 24.6 | 22.2 | 26 | 50 or lower |
| (viscosity change, %) | | | | | | |

1) Fluidity: Tested according to KS M-2095
2) Ductility: Tested according to KS M-2095
3) Curability: Tested according to KS M-2095
4) Adhesion strength: Tested according to KS M-2095, 3718
5) Cold resistance: Tested according to ASTM D-1912
6) Heat resistant cyclability: Tested according to KS M-5496
7) Water proofness: Tested according to KS M-3730
8) Finish Coating resistant: Tested according to KS M-5507
9) Storage stability: Tested according to ASTM F-1105

As can be seen from the physical property test result given in Table 4, the sealer compositions according to the present invention have comparable or better physical properties as compared to the conventional sealer compositions.

As described above, the sealer compositions according to the present invention can reduce the weight of the automobile because of low specific gravity and, thereby, can improve fuel efficiency. Especially, with superior humidity resistance, it can improve process efficiency during coating and curing of the sealer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A composition for humidity proof heat sealer having low specific gravity, which comprises:
(1) 20 to 35 weight % of a polyvinyl chloride resin;
(2) 20 to 35 weight % of a filler comprising 60 to 95 weight % of calcium carbonate, 2 to 20 weight % of hollow microspheres and 2 to 20 weight % of microspheres;
(3) 5 to 10 weight % of a moisture absorbent comprising 50 to 75 weight % of non-coated calcium oxide and 25 to 50 weight % of coated calcium oxide;
(4) 25 to 35 weight % of a plasticizer;
(5) 1 to 15 weight % of an adhesion promoter; and
(6) 1 to 5 weight % of a heat stabilizer.

2. The composition as set forth in claim 1, wherein the polyvinyl chloride resin comprises 30 to 55 weight % of a homopolymer resin, 30 to 55 weight % of a copolymer resin and 10 to 25 weight % of a blend resin.

3. The composition as set forth in claim 1, wherein said calcium carbonate has specific gravity of 1.7 to 1.9, said hollow microspheres have specific gravity of 0.7 to 0.9, and said microspheres have specific gravity of 0.05 to 0.1.

4. The composition as set forth in claim 1, wherein the plasticizer is at least one selected from diethylhexyl phthalate (DEHP), dibutyl phthalate (DBP), diisononyl phthalate (DINP), diisodecyl phthalate (DIDP) and butylbenzyl phthalate.

5. The composition as set forth in claim 1, which comprises 1 to 5 parts by weight of a low boiling point solvent having viscosity of 2 to 2.5 cst (centistokes, at 40° C.), based on 100 parts by weight of the humidity-proof sealer composition.
